(19) United States
(12) Patent Application Publication
(10) Pub. No.: US 2003/0134006 A1
(43) Pub. Date: Jul. 17, 2003

(54) Method of vegetable processing

(76) Inventor: Uchenna N. Chukwu, Minnetonka, MN (US)

Correspondence Address: KINNEY & LANGE, P.A., THE KINNEY & LANGE BUILDING, 312 SOUTH THIRD STREET, MINNEAPOLIS, MN, 55415-1002, US

(21) Appl. No.: 09/495,960

(22) Filed: Feb. 2, 2000

Related U.S. Application Data
(63) Continuation-in-part of application No. 09/196,844, filed on Nov. 20, 1998, now Pat. No. 6,033,692.

(51) Int. Cl. A23G 1/02

(52) U.S. Cl. 426/44

(57) ABSTRACT

A method of processing a vegetable that includes providing a vegetable composition having a first outer layer to which an enzyme is applied for a time that is sufficient to form an enzyme-degraded vegetable. The enzyme-degraded vegetable is capable of absorbing components, such as water, additives or enzymes that further process the vegetable.

### CROSS-REFERENCE TO RELATED APPLICATION(S)

This application is a continuation-in-part of application Ser. No. 09/196,844, filed on Nov. 20, 1998, which is incorporated by reference.

### BACKGROUND OF THE INVENTION

The present invention generally relates to a vegetable product and to a method of using enzymes to process the vegetable product. More specifically, the present invention relates to a vegetable product with improved processing and nutritional characteristics and to a method of making the vegetable product The present invention further relates to an enzymatic method of processing a vegetable product.

During the last several years, consumer interest in eating foods that are nutritionally balanced with an adequate source of protein, fat, carbohydrates, fiber, vitamins and minerals has increased. Growing concern over chronic diseases, such as cancer, diabetes and heart disease have motivated consumers to seek foods for consumption that are effective in treating chronic diseases while promoting a healthier lifestyle. As evidenced by the growing health foods market, whole foods market, and dietary supplements market, consumers believe that consumption of phytochemicals in their diet may contribute to a lower risk and a lower incidence of chronic diseases. As used herein, a “phytochemical” means a chemical substance produced by a plant with a demonstrated health benefit.

Consumption of vegetables having phytochemicals may pose several problems. The presence of anti-nutritional components such as indigestible sugars, enzyme inhibitors, nutrient-binding substances or toxic compounds typically render a vegetable containing a phytochemical unfit for consumption Low concentrations of the desired phytochemical in the vegetable is another problem for consumers, especially if the concentration of the phytochemical is considered too low to deliver a health benefit.

Heat or pressure processing of vegetables to eliminate anti-nutritional components in the vegetable prior to consumption is the traditional approach used by food manufacturers. However, food manufacturers may require modification of the vegetable, such as hydration of the vegetable prior to processing, in order to adequately manufacture the vegetable. Unfortunately, modification of the vegetable prior to processing may include complicated steps that increase the overall costs associated with vegetable production. Thus, an urgent need presently exists to develop an effective food process that reduces the complexity and costs associated with vegetable production. Furthermore, there is a need to develop an effective method of eliminating any anti-nutritional component from vegetables that minimize consumption of vegetables.

### BRIEF SUMMARY OF THE INVENTION

A method of processing a vegetable composition that includes providing a vegetable having a first outer layer and applying an enzyme to the first outer layer of the vegetable for a time that is sufficient to form an enzyme-degraded vegetable. The enzyme-degraded vegetable is capable of absorbing components such as water, additives or other enzymes that may further process the vegetable

### BRIEF DESCRIPTION OF THE DRAWINGS

FIG. 1 is a greatly enlarged cross-sectional view of a portion of a bean.

### DETAILED DESCRIPTION

The present invention generally relates to a vegetable composition and to a method of using enzymes to process this vegetable composition. More specifically, the present invention relates to a vegetable composition with improved processing and nutritional characteristics and to a method of making this vegetable composition. The present invention further relates to an enzymatic method of processing a vegetable composition. The following grouping of embodiments is made solely in the interest of defining the unique features of this novel invention. No grouping of embodiments is intended to be, nor should be interpreted as being any form of admission or a statement as to the scope or obviousness of any feature of the invention.

1. A Method of Improving Absorption by a Vegetable Composition.

It has been discovered that if one or more enzyme(s) that are capable of at least degrading one or more target substrates in a first outer layer of a vegetable composition, is applied to the first outer layer of the vegetable composition, the enzyme(s) degrade the first outer layer of the vegetable composition to form an enzyme-degraded vegetable composition having a compromised first outer layer. The enzyme-degraded vegetable composition is rendered absorbent by the action of the enzyme on the first outer layer and is capable of absorbing components, such as water, additives, enzymes, or any combination thereof.

The discovery that an enzyme may be used to compromise the first outer layer of a vegetable composition has been disclosed in Serial application Ser. No. 09/196,844, which is incorporated herein by reference. Even more surprising is the discovery that an enzyme-degraded vegetable composition having a compromised first outer layer may absorb components, such as water to hydrate the vegetable composition; additives, such as vitamins or minerals that modify the vegetable composition; or enzymes, hereinafter referred to as the second enzyme composition, that are capable of degrading target substrates within the vegetable composition

The present invention is a creative method of processing a vegetable that may traditionally require one or more complicated manufacturing step(s), such as a lengthy hydration step, or a large amount of heat and/or pressure to attain an adequately processed vegetable. The formation of the enzyme-degraded vegetable simplifies a manufacturing process for a vegetable since the first outer layer that functions as a barrier during the manufacturing process is compromised when practicing the present invention. Furthermore, degradation of the first outer layer of the vegetable composition also increases the nutritional characteristics of the vegetable composition since the first outer layer typically includes a fibrous network of indigestible polysaccharides.

As used herein, the term “vegetable” means a plant-based food that originated as a living organism of the Plantae kingdom All references to “vegetable” are to be understood as encompassing any genetically-altered copy of the plant that originated as a living organism of the Plantae kingdom. Furthermore, the term “vegetable” encompasses leaves, seeds, roots, tubers, bulbs, flowers, fruits, stems, shoots, nuts, or any combination of any of these that originated as a living organism of the Plantae kingdom.

The vegetable composition may be characterized as including a first outer layer, a second inner layer and anti-nutritional components located in the continuous first outer layer and/or the second inner layer. The first outer layer may substantially cover and overlay the second inner layer. The first outer layer may also be bonded to the second inner layer via cementing substances, such as, for example, pectic substances.

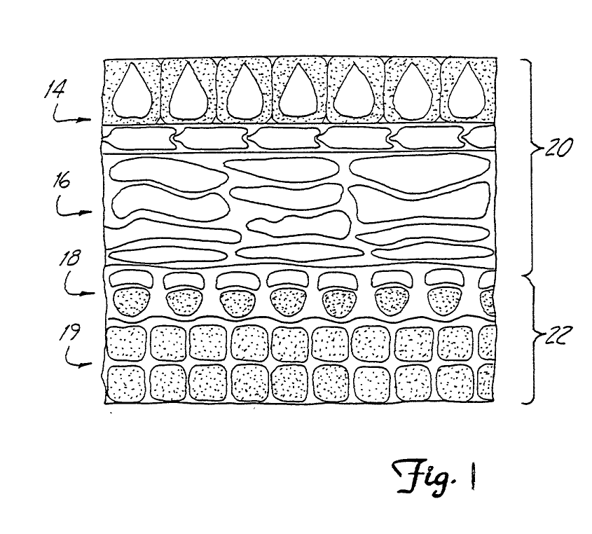

The first outer layer of the vegetable composition typically includes a fibrous network of cellulose; hemicellulose; polysacccharides of five-carbon sugars; lignin; pectic substances, such as protopectin, pectic acid, pectin, or any combination thereof, vitamins; minerals; anti-nutritional components; or any combination of any of these. Some non-exhaustive examples of the continuous first outer layer may include a seed coat of a legume or lentil; a bran layer of a grain, a stem wall of a vegetable; a skin of a root, tuber, and/or bulb vegetable; a peel of a fruit; a testa or a seed wall of a nut. An example of a continuous first outer layer is a seed coat 20 of a bean, that is illustrated in FIG. 1. The seed coat 20 includes several layers of cells, including the outer integument 14 and inner integument 16

Preferably, the first outer layer of the vegetable composition is not modified by mechanical means, such as by grinding, pulverizing, grating, or any combination thereof, that removes the first outer layer of the vegetable composition prior to practicing the present invention. Still more preferably, the first outer layer is in contact with the second inner layer while practicing the present invention.

The second inner layer of the vegetable composition generally includes starch granules; fat globules; fiber; proteins; vitamins; minerals; water; anti-nutritional components; or any combination of any of these. All references to the second inner layer is also understood to encompass the inner portion of the vegetable composition and thus, the second inner layer may also include seeds embedded in the vegetable composition. An example of the second inner layer is the cotyledon 22 of a bean as best illustrated in FIG. 1. The cotyledon 22 includes the epidermis 18, and the storage parenchyma cells 19 located below the epidermis 18. Some non-exhaustive examples of anti-nutritional components of a vegetable composition include flatulence-causing sugars, such as, for example, raffinose, verbascose and stachyose; lectins; nutrient-binding substances, such as phytic acid, other indigestible polysaccharides; enzyme inhibitors, such as trypsin inhibitor; or toxic compounds, such as goitrogens, solanine, or oxalic acid.

Vegetable compositions that are generally in the form of a seed typically have less than about 40 weight percent moisture content, and preferably less than about 30 weight percent moisture content. An example of a seed that may be used to practice the present invention includes beans, which are the seeds from a plant of a Leguminosae family. A bean typically has about 12 to about 14 weight percent moisture content and includes pinto beans, light red kidney beans, black-eye peas, lentils, mung beans, pinkie beans, great northern beans, green lima beans, yellow lima beans, garbanzo beans, carob beans, cacao beans, coffee beans, split and/or whole peas, peanuts, yellow peas, green peas, soybeans, black beans, vanilla bean, or any other edible seed from plants of the Leguminosae family. Other non-exhaustive examples of seeds that may be used in accordance with the present invention include amaranth seeds, watermelon seeds, pomegranate seeds, sunflower seeds, safflower seeds, poppy seeds, sesame seeds, alfalfa seeds, caraway seeds, cardamom seeds, celery seeds, chia seeds, coriander seeds, dill seeds, fennel seeds, fenugreek seeds, flax seeds, milk thistle seeds, nutmeg seeds, mustard seeds, psyllium seed; grains such as barley, buckwheat, bulghur, corn, millet, oats, rice, rye, triticale, wheat, wild rice, brown rice; or any seed from recognized edible vegetable source.

A vegetable composition that generally is in the form of a nut may also have less than about 40 weight percent moisture content. As used herein, a “nut” means a hard shelled dry fruit or seed with a separable first outer layer that substantially encloses an interior kernel. Furthermore, the first outer layer may include a second inner layer, located underneath the first outer layer, that substantially covers and overlays the interior kernel. The first outer layer or the second inner layer located underneath the first outer layer may be used in accordance with the present invention. Some non-exhaustive examples of vegetable compositions in the form of a nut that may be used in accordance with the present invention include an acorn nut, an almond nut, a brazil nut, a butternut, a cashew nut, a chestnut, a coconut, a filbert nut, a hazelnut, a hickory nut, a macadamia nut, a pecan nut, a pine nut, a pistachio nut, a walnut, or any recognized edible nut from a recognized edible vegetable source.

A vegetable composition that generally is in the form of a leaf may have more than about 30 weight percent moisture content. Some non-exhaustive examples of vegetable compositions in the form of a leaf that may be used in accordance with the present invention include brussel sprouts, purslane, watercress, cabbage, sorrell, chickweed, endive, escarole, parsley; greens, such as kale, collards, turnip, mustard, spinach; or any edible leaf from any recognized vegetable source.

A vegetable composition that generally is in the form of a root, tuber, and/or bulb, may have at least about 25 weight percent moisture content. Some non-exhaustive examples of vegetables in the form of a root, tuber and/or bulb that may be used in accordance with the present invention include beets, swiss chard, burdock, garlic, onion, carrot, chicory root, kudzu, parsnip, radish, such as red radish, daikon radish, scarlet globe radish, cherry belle radish, breakfast radish, or white icicle radish, potato, such as white potato, sweet potato, or yams; rutabaga, turnip, tapioca, salsify, or any edible root, tuber and/or bulb from any recognized edible vegetable source.

A vegetable composition that generally is in the form of a flower may have at least about 75 weight percent moisture content. Some non-exhaustive examples of vegetables in the form of a flower that may be used in accordance with the present invention include artichoke, Jerusalem artichoke, broccoli, cauliflower, or any edible flower from any recognized edible vegetable source.

A vegetable composition that generally is in the form of a stem and/or shoot may have at least about 60 weight percent moisture content Some non-exhaustive examples of vegetables in the form of a stem that may be used in accordance with the present invention include asparagus, bamboo shoots, celery, kohlrabi, rhubarb, such as Chinese rhubarb and garden rhubarb or any other edible stem and/or shoot from any recognized edible vegetable source.

A vegetable composition that generally is in the form of a fruit may have at least about 85 weight percent moisture content. Some non-exhaustive examples of vegetables in the form of a fruit that may be used in accordance with the present invention include zucchini, cucumber, tamarind, eggplant, avocado, lychees, mushrooms, olive, peppers, tomato, pumpkin, squash, gourd, or any edible fruit of any recognized edible vegetable source.

Other non-exhaustive examples of vegetable compositions that may be used in accordance with the present invention include seaweed, such as seaweed from blue-green algae (Division Cyanophyta), seaweed from green algae (Division Chlorophyta), seaweed from red algae (Division Rhodophyta), seaweed from brown algae (Division Pheophyta); jicama; or pimento or any vegetable composition from any recognized edible vegetable source.

As used herein, the term “enzyme” means any complex protein produced by a living cell that is capable of at least catalyzing a specific biochemical reaction on one or more target substrates. The term “enzyme” is also meant to encompass any complex protein capable of catalyzing a specific biochemical reaction that is substantially free of any microorganism. All references to enzyme is also understood as encompassing any synthetically-produced identical copy of the enzyme that is identical in molecular structure to the enzyme that originated in a living organism.

As disclosed in Serial application Ser. No. 09/196,844, the enzyme(s) that may be used to degrade the first outer layer of the vegetable composition, hereinafter referred to as the first enzyme composition, may be generally characterized as a carbohydrase. As used herein, the term “carbohydrase” means any enzyme that is capable of at least catalyzing hydrolysis of a carbohydrate-containing target substrate. One particular form of a carbohydrase that is used in the first enzyme composition in accordance with the present invention is cellulase Cellulase may be derived from a number of different sources, such as fungal sources, plant sources, microbial sources, animal sources, or any combination of any of these.

Besides cellulase, it is believed that other carbohydrases, such as hemicellulase, alpha-galactosidase, invertase, mannanase, beta-gluconase, beta-glucanase, arabinase, xylanase, beta-galactosidase, beta-fructofuranosidase, alpha-amylase, beta-amylase, pectinase, pectin depolymerase, pectin methyl esterase, pectin lyase, glucoamylase, oligo-1,6 glucosidase, lactase, beta-d-glucosidase, or any combination of any of these provide sufficient carbohydrase activity and are consequently suitable additional non-exhaustive examples of a carbohydrase that may be used to degrade the first outer layer of the vegetable composition in accordance with the present invention. Like cellulase, the other carbohydrases, such as hemicellulase, alpha-galactosidase, mannanase, beta-gluconase, beta-glucanase, arabinase, xylanase, beta-galactosidase, beta-fructofuranosidase, alpha-amylase, beta-amylase, pectinase, invertase, pectin depolymerase, pectin methyl esterase, pectin lyase, glucoamylase, oligo-1,6 glucosidase, lactase, or beta-d-glucosidase, may be derived from a number of different fungal sources, plant sources, microbial sources, animal sources or any combination of any of these. Though subsequent references to the first enzyme composition specifically addresses cellulase, it is believed that other carbohydrases, such as hemicellulase, alpha-galactosidase, mannanase, beta-gluconase, beta-glucanase, arabinase, xylanase, beta-galactosidase, alpha-amylase, beta-amylase, pectinase, invertase, pectin depolymerase, pectin methyl esterase, pectin lyase, glucoamylase, oligo-1,6 glucosidase, lactase, invertase, beta-d-glucosidase, and any of these listed carbohydrases in any combination may be substituted in place of, or used in any combination with, cellulase for degradation of the first outer layer in accordance with the present invention. Preferably, a blend of cellulase and hemicellulase is used in the present invention to degrade the first outer layer of the vegetable composition. A preferred example of the first enzyme composition is Viscozyme®L, available from Novo Nordisk Biochem North America, Inc., of Franlinton, N.C. Another example of the first enzyme composition is Econase® CE, available from Enzyme Development Corporation of New York, N.Y.

Typically, enzymes have not been actively pursued for use in vegetable processing, due to the generally low activity associated with enzymes and the high cost of using enzymes. However, the value of using enzymes to process vegetables in accordance with the present invention clearly demonstrates the practicality of incorporating enzymes in vegetable production. Furthermore, even though a vegetable composition is exposed to a carbohydrase in accordance with the present invention, such application of carbohydrases do not negatively impact the nutritional and mouth-feel characteristics of the vegetable composition.

Enzymes are typically a low temperature and a low pressure process that are capable of catalyzing chemical reactions with a high degree of accuracy. Enzymes may be naturally-occurring and may be derived from edible animal sources, edible plant sources, edible fungal sources, edible microbial sources, or any combination of any of these. Thus, enzyme toxicity is generally low towards humans. Furthermore, using enzymes typically requires low concentrations that improve the cost-effectiveness of applying enzymes to vegetable processing Enzymes are generally recognized as safe by the Food and Drug Administration and may be readily inactivated by higher temperatures, high pressures or a change in the chemical composition of the system that include the enzymes.

When enzymes are used during vegetable processing, enzymes may be applied in any form, such as a granular form, or a vapor form, or as part of an aqueous enzyme composition. The application form that is selected preferably permits the enzyme to (1) contact the vegetable composition being treated, and (2) remain in contact with the vegetable composition being treated for a time that is sufficient to degrade the target substrate. Preferably, the first enzyme composition and/or the second enzyme composition is applied to the vegetable composition as part of an aqueous enzyme composition.

The aqueous enzyme composition may include one or more enzyme component(s), one or more optional catalyst component(s), one or more optional pH-modifying component(s), one or more optional additive(s) or one or more optional solvent component(s). The components of the aqueous enzyme composition may be supplied as individual components, or supplied in various prepared mixtures of two or more components, that are subsequently combined to form the aqueous enzyme composition.

The aqueous enzyme composition may be based on one or more enzyme component(s). The enzyme component may include only the enzyme, the enzyme and water, or may optionally include additional components. The concentration of the enzyme in the enzyme component may generally range from about 0.0001 weight percent to about 100 weight percent, based on the total weight of the enzyme component. The enzyme component may optionally include sucrose, fructose, ash, alcohol, and any other components that are compatible with, and do not interfere with the biochemical rate of catalysis of the enzyme.

The concentration of enzyme component in the aqueous enzyme composition may range from about 0.0001 weight percent enzyme component to about 50 weight percent enzyme component, based on the total weight of the aqueous enzyme composition when practicing the present invention. Preferably, the concentration of enzyme component is an amount that is sufficient to catalyze the biochemical reaction in a vegetable composition. Still more preferably, less than about 10 weight percent enzyme component, based on the total weight of the aqueous enzyme composition is applied to the vegetable composition. The biochemical rate of catalysis is typically maximized at the upper end of this range. However, application of the enzyme composition at concentrations near the upper end of this range, while being effective for degradation, may be considered wasteful and cost-prohibitive. The enzyme component(s) may be supplied as individual components, or supplied in various prepared mixtures of two or more components, that are subsequently combined to form the enzyme component(s). Additionally, the enzyme component may be supplied in granular form, vapor form, or as part of an aqueous enzyme component.

The aqueous enzyme composition may optionally include one or more catalyst component(s) in a form that is readily applied to the vegetable composition. A catalyst, when included as part of the aqueous enzyme composition, generally enhances the biochemical rate of catalysis of the enzyme component. Increasing the biochemical rate of catalysis of the enzyme component may decrease the application time of the aqueous enzyme composition to the vegetable composition or the amount of the aqueous enzyme composition applied to the vegetable composition.

Alternatively, the catalyst component may be applied separately from the aqueous enzyme composition, either before, during, or after application of the aqueous enzyme composition to the vegetable composition. Additionally, the source(s) of the catalyst may be applied in particulate form, as part of an aqueous composition, or in a vapor form so long as the particular form selected results in application to and uptake by the vegetable composition. Some non-exhaustive examples of catalysts that may be included as part of the aqueous enzyme composition are salts that include calcium ions, copper ions, magnesium ions, iron ions, sodium ions, zinc ions, manganese ions, potassium ions, or any combination thereof The catalyst component(s) may be supplied as individual components, or supplied in various prepared mixtures of two or more components, that are subsequently combined to form the catalyst component(s).

The aqueous enzyme composition may include one or more pH-modifying component(s) that are capable of adjusting the acidity, hereinafter referred to as the pH, of the aqueous enzyme composition. The pH of the aqueous enzyme composition will vary depending on the enzyme(s) present in the aqueous enzyme composition. The pH modification to a value that facilitates a maximum biochemical rate of catalysis of the enzyme component(s) during application of the aqueous enzyme composition to the vegetable composition is considered advantageous to the present invention. The pH value may range from about 2.0 to about 7.0 Preferably, the pH of the first enzyme composition applied in the form of an aqueous enzyme composition, is about 3.0 to about 7.0. Still more preferably, the pH of the aqueous enzyme composition that includes the first enzyme composition as part of the aqueous enzyme composition is about 3.5 to about 7.0. Some non-exhaustive examples of pH modifying substances include organic acids, such as acetic acid tartaric acid, malic acid, succinic acid, citric acid, or the like; phosphoric acid; or buffering agents of such organic acids, such as sodium acetate, sodium malate, sodium succinate, sodium citrate, or the like.

Some non-exhaustive examples of optional additives that may be included as part of the aqueous enzyme composition include natural and/or artificial flavors; artificial colors; naturally-occurring pigments, such as, for example, chlorophyll, anthocyanin, betalain, betaine, carotenoid, anthoxanthins, herbs; spices, vitamins; minerals; plant extracts; essential oils; sugars such as sucrose, fructose, glucose, or maltose; preservatives; emulsifiers, such as mono-glycerides, distilled mono-glycerides, di-glycerides, distilled di-glycerides, or lecithin; any additive that improves the aqueous enzyme composition application to, uptake by, or subsequent processing of the vegetable composition; or any combination of any of these. The optional additives may be supplied as individual components, or supplied in various prepared mixtures of two or more components, that are subsequently combined to form the optional additives.

The aqueous enzyme composition may also include one or more solvent component(s). The solvent component(s) preferably facilitate homogenous blending of the enzyme component(s), the optional catalyst component(s), the optional pH-modifying component(s), the optional additives, or any combination thereof. The solvent component(s) preferably facilitate aqueous enzyme composition application to, and uptake by the vegetable composition Some non-exhaustive examples of solvents that may be included in the aqueous enzyme composition include water; oils; alcohol, such as ethanol, methanol, propanol, butanol, or the like; hexane; or any combination thereof. The solvent component(s) may be supplied as individual components, or supplied in various prepared mixtures of two or more components, that are subsequently combined to form the solvent component(s).

Liquid water is the preferred solvent for the aqueous enzyme composition. The amount of liquid water included as part of the aqueous enzyme composition depends on the initial concentration of water in the vegetable composition, the biochemical rate of catalysis, and/or the desired final product characteristics of the enzyme-degraded vegetable composition. Generally, the amount of the aqueous enzyme composition is such that the vegetable composition is completely contacted by the aqueous enzyme composition. Preferably, the aqueous enzyme composition is about 2 to about 5 times the weight of the vegetable composition.

An example of component concentration ranges for a preferred formulation of the aqueous enzyme composition is presented in Table 1 below.

TABLE 1

| COMPONENT | CONCENTRATION (weight percent)* |
|---|---|
| Enzyme component | about 0.0001 to about 99 |
| Catalyst component | 0 to about 25 |
| pH-modifying component | 0 to about 10 |
| Optional additives | 0 to about 50 |
| Solvent components | 0 to about 99 |

*based on the total weight of the aqueous enzyme composition

In general, any conventional blending apparatus and technique that is suitable for homogeneously blending the enzyme component(s), the optional catalyst component(s), the optional pH-modifying component(s), the optional additives, the optional solvent component(s), or any combination thereof, such as a mixer, may be used to form the aqueous enzyme composition.

As used herein, the term “application” means to apply the aqueous enzyme composition to the vegetable composition by spraying; knife-coating; spreading; printing; soaking; exposing; immersing; slop-coating; dip-coating; roller-coating; dipping; contacting; brush-coating; squirting; submerging; foam padding, leaf-sprinkling; sprinkling; pouring; slop-padding; or any combination thereof.

The temperature of the aqueous enzyme composition depends on the initial temperature of the vegetable composition, the temperature for the optimum biochemical rate of catalysis of the enzyme component(s), and/or the desired characteristics of the enzyme-degraded vegetable composition. Generally, the temperature of the aqueous enzyme composition may range from about 30° F. to about 250° F. Preferably, the temperature of the aqueous enzyme composition is at the optimum temperature for a maximum biochemical rate of catalysis of the enzyme component(s) of the aqueous enzyme composition. Although the aqueous enzyme composition may be applied to the vegetable composition at a constant temperature, the temperature of the aqueous enzyme composition may be increased at any time during application of the aqueous enzyme composition to the vegetable composition Generally, increasing the temperature increases the biochemical rate of catalysis and/or water absorption. However, a negative impact on the texture of the vegetable composition may occur if the temperature of the aqueous enzyme composition is too high, such as more than about 250° F., or the temperature of the aqueous enzyme composition is changed too rapidly during application.

Steam may also be injected into the aqueous enzyme composition to optionally increase the temperature of the aqueous enzyme composition applied to the vegetable composition, to optionally increase the moisture content of the vegetable composition, to optionally gelatinize any starch granules of the vegetable composition, to optionally increase the efficacy of the biochemical rate of catalysis of the aqueous enzyme composition, or to optionally deactivate the enzyme component in the aqueous enzyme composition.

The length of time the aqueous enzyme composition is applied to the vegetable composition typically depends on the vegetable composition, the desired degree of degradation, and/or the desired characteristics of the enzyme-degraded vegetable composition. The length of time used in practicing the present invention may range from about 1 second to more than about 24 hours.

Once sufficient degradation of the vegetable composition has occurred, the vegetable composition may be drained of the aqueous enzyme composition and the vegetable composition further subjected to processing steps, such as, for example, blanching, that inactivates any enzyme component(s) that may remain in the vegetable composition. Alternatively, transferring the enzyme-degraded vegetable composition still in the aqueous enzyme composition for further processing by freezing, hydrating, steaming, freeze-drying, canning, frying, boiling, drying, extrusion, cooking, baking, roasting, pulverizing, fermenting, enzyme, pasteurizing, extracting, milling, puffing, steam-pressure cooking, or any combination thereof is also effective in deactivating any enzyme component(s) in the vegetable composition.

While not wanting to be bound to theory, it is believed that the first enzyme composition degrades the first outer layer of a vegetable composition by degrading target substrates located in the first outer layer and/or the second inner layer of the vegetable composition to form an enzyme-degraded vegetable composition. The first enzyme composition may therefore transform the first outer layer and/or the second inner layer into a crater-like, mesh-like or sieve-like network of degraded sites. Additionally, the first enzyme composition may generate holes throughout the first outer layer and/or the second inner layer of the vegetable composition that facilitates absorption of water, additives, or enzymes. The first enzyme composition may also target a wide range of substrates within the vegetable composition, therefore, the breakdown of these substrates may serve to tenderize the vegetable composition and aid in the reduction of cook time of the vegetable composition.

Partial degradation of the first outer layer of the vegetable composition permits absorption of the enzyme component(s), the optional pH-modifying component(s), the optional additives, the optional solvent component(s), or any combination thereof, into the vegetable composition while the aqueous enzyme composition that includes the first enzyme composition is still in contact with the first outer layer. Thus, absorption of the enzyme component(s), the optional pH-modifying component(s), the optional additives, the optional solvent component(s), or any combination thereof, into the vegetable composition may occur during or after application of the aqueous enzyme composition to the vegetable composition when practicing the present invention. The rate at which the enzyme-degraded vegetable composition is capable of absorbing the enzyme component(s), the optional pH-modifying component(s), the optional additives, the optional solvent component(s), or any combination thereof, may be expressed as the absorbency of the vegetable composition. As used herein, the absorbency of the vegetable composition may be characterized in units of grams of the enzyme component, the optional pH-modifying component, the optional additive, or the optional solvent component per minute of application time. The specific absorbency of a vegetable composition is defined herein as the absorbency of an enzyme-degraded vegetable composition per gram of enzyme-degraded vegetable composition.

The benefits of an enzyme-degraded vegetable composition include an increase in the absorbency of the vegetable composition of a component, such as, for examples, water, additives, or other enzymes that may be used to further process the vegetable composition. In addition, processing the enzyme-degraded vegetable composition by conventional means, such as by freezing, hydrating, steaming, freeze-drying, canning, frying, boiling, drying, extrusion, cooking, baking, roasting, pulverizing, fermenting, enzyme, pasteurizing, extracting, milling, puffing, steam-pressure cooking, or any combination thereof is improved since the first outer layer of the vegetable composition that typically functions as a barrier during conventional is degraded.

As an example, a series of experiments were conducted using pinto beans as the vegetable composition to improve the absorbency of a vegetable composition in accordance with the present invention. Approximately 740 grams of water was added to an amount of vinegar and brought to any one of the temperature ranges specified in Table 2 below. About 12 to about 13 grams of Viscozyme®L, supplied by Novo Nordisk Biochem North America Inc., of Franklinton, N.C., was added to the water and vinegar mixture to form an aqueous enzyme composition with an initial pH of about 4.0. Viscozyme®L is a blend of cellulase and hemicellulase enzymes. About 250 grams of pinto beans for each experiment conducted at any one of the temperature ranges were added to the aqueous enzyme composition and allowed to soak for about 60 minutes. The pinto beans were then drained, and transferred to about 750 grams of water at about 200° F. for about a 5 minute blanch. The experiments were randomized and repeated twice to ensure reproducibility. A control batch of pinto beans were subjected to an aqueous composition that did not include enzymes. Furthermore, the control batch of pinto beans was allowed to soak for about 240 minutes. The results are presented below in Table 2:

TABLE 2

| | | CONC. | | |
|---|---|---|---|---|
| VEGETABLE | TEMP | (% by | ABSORB- | SPECIFIC |
| COMPOSITION | (° F.) | weight) | ENCY* | ABSORBENCY** |
| Pinto (1) | 50-60 | 5% | 0.93 | 0.00372 |
| Pinto (2) | 50-60 | 5% | 0.75 | 0.00300 |
| Pinto (1) | 110-120 | 5% | 3.21 | 0.01284 |
| Pinto (2) | 110-120 | 5% | 2.67 | 0.01068 |
| Pinto (1) | 150-160 | 5% | 3.18 | 0.01272 |
| Pinto (2) | 150-160 | 5% | 3.27 | 0.01308 |
| Pinto (control) | 150-160 | 0% | 1.17 | 0.00468 |

*grams of water per minute of soak time
**grams of water per minute of soak time per gram of bean

Table 2 illustrates that incorporating a blend of cellulase and hemicellulase as part of the first enzyme composition that is subsequently applied to the first outer layer of a vegetable composition increases both the absorbency and the specific absorbency of a vegetable composition by a factor of about 3. Table 2 also illustrates the effect of varying the temperature of the aqueous enzyme composition on the absorbency of the vegetable composition. As was observed in the experiments of Table 2, an increase in the temperature range of the aqueous enzyme composition resulted in an increase in both the absorbency and specific absorbency of the vegetable composition.

2. A method of Improving Hydration of a Vegetable Composition

It has been discovered that the enzyme-degraded vegetable composition of the present invention is capable of absorbing water to form a hydrated vegetable composition. The method of using one or more enzymes to hydrate a vegetable composition has been disclosed in Serial application Ser. No. 09/196,844.

Serial application Ser. No. 09/196,844 further discloses that the aqueous enzyme composition that includes cellulase and carbohydrase enzymes dramatically increases the rate of hydration of beans. Typically, an 8-12 hour water soak is used to hydrate dry edible beans to about 50 weight percent moisture content at a temperature of about 80° F. or below. When practicing the present invention, the time required to reach about 50 weight percent moisture content in beans may be reduced to 1-2 hours.

The vegetable composition preferably has less than about 40 weight percent moisture content, and still more preferably, less than about 30 weight percent moisture content when hydrating a vegetable composition in accordance with the present invention. Some non-exhaustive examples of vegetable compositions that may be hydrated in accordance with the present invention include pinto beans, light red kidney beans, black-eye peas, lentils, mung beans, pinkie beans, great northern beans, green lima beans, yellow lima beans, garbanzo beans, carob beans, cacao beans, coffee beans, split and/or whole peas, yellow peas, green peas, peanuts, soybeans, black beans, vanilla bean, or any edible seed from plants of the Leguminosae family, amaranth seeds, watermelon seeds, pomegranate seeds, sunflower seeds, safflower seeds, poppy seeds, sesame seeds, alfalfa seeds, caraway seeds, cardamom seeds, celery seeds, chia seeds, coriander seeds, dill seeds, fennel seeds, fenugreek seeds, flax seeds, milk thistle seeds, nutmeg seeds, mustard seeds, psyllium seed, grains such as barley, buckwheat, bulghur, corn, millet, oats, rice, rye, triticale, wheat, wild rice, brown rice, any seed from recognized edible vegetable source, nuts, such as an acorn nut, an almond nut, a brazil nut, a butternut, a cashew nut, a chestnut, a coconut, a filbert nut, a hazelnut, a hickory nut, a macadamia nut, a pecan nut, a pine nut, a pistachio nut, a walnut, or any recognized edible nut from a recognized edible vegetable source, or any vegetable composition having less than about 40 weight percent moisture content.

While not wanting to be bound to theory, it is believed that the blend of a cellulase and a hemicellulase as part of the aqueous enzyme composition degrades the first outer layer of the vegetable composition and forms holes that compromise the integrity of the first outer layer to form an enzyme-degraded vegetable composition. The compromised integrity in the first outer layer of the enzyme-degraded vegetable composition allows water to enter through the first outer layer to hydrate the vegetable composition. As water is continuously absorbed by the vegetable composition, the second inner layer may be hydrated which may result in an enlargement and/or swelling of the vegetable composition

The aqueous enzyme composition that includes a blend of cellulase and hemicellulase remains in contact with the first outer layer of the vegetable composition for a time that is sufficient to degrade the first outer layer, such as, for example, about 1 second to about 12 hours. Furthermore, water may be applied to the enzyme-degraded vegetable composition for a time that is sufficient for the enzyme-degraded vegetable composition to absorb water, such as, for example, a time of about 1 second to about 12 hours. Preferably, the aqueous enzyme composition remains in contact with the first outer layer for about 5 minutes to about 120 minutes, and the water remains in contact with the first outer layer for about 5 minutes to about 120 minutes.

The inventive method of improving the hydration of a vegetable composition in accordance with the present invention is a significant improvement in the art of vegetable processing. Typically, hydration of vegetables is accompanied by high energy, equipment costs or excessive hydration periods. The present invention accomplishes an increase in the moisture content of the vegetable composition without a high energy requirement nor capital investment and a short hydration period.

Once sufficient hydration of the vegetable composition occurs, the hydrated vegetable composition may be drained of the aqueous enzyme composition and the vegetable composition further subjected to processing steps, such as, for example, blanching, that inactivates any enzyme component(s) that may remain in the vegetable composition. Alternatively, transferring the hydrated vegetable composition still in the aqueous enzyme composition for further processing by freezing, hydrating, steaming, freeze-drying, canning, frying, boiling, drying, extrusion, cooking, baking, roasting, pulverizing, fermenting, enzyme, pasteurizing, extracting, milling, puffing, steam-pressure cooking, or any combination thereof is also effective in deactivating any enzyme component(s) in the vegetable composition.

As an example, a variety of beans were hydrated in accordance with the present invention. Approximately 740 grams of water was added to an amount of vinegar and brought to a temperature specified in Table 3 below About 2 to about 3 grams of Viscozyme®L, supplied by Novo Nordisk Biochem North America Inc., of Franklinton, N.C., was added to the water and vinegar mixture to form an aqueous enzyme composition with an initial pH of about 4.0. Viscozyme®L is a blend of cellulase and hemicellulase enzymes. About 250 grams of each variety of bean specified in Table 3 below was added to the aqueous enzyme composition and allowed to soak for about 120 minutes The beans were then drained, and transferred to about 750 grams of water at about 200° F. for about a 5 minute blanch The percent hydration for each variety of bean is presented in Table 3 below A control hydration experiment for each variety of bean using an aqueous composition that did not include enzymes, at a temperature range of about 150° F. to 160° F. for about 4 hours is also presented in Table 3 below.

TABLE 3

| | | | CONTROL |
|---|---|---|---|
| VEGETABLE | AVERAGE | PERCENT | (PERCENT |
| COMPOSITION | TEMP. (° F.) | HYDRATION | HYDRATION) |
| Light Red Kidney | about 141 | about 53 | about 50 |
| Pinto Bean | about 138 | about 51 | about 54 |
| Blackeye | about 136 | about 52 | about 54 |
| Pinks | about 136 | about 48 | about 50 |
| Great Northern Bean | about 146 | about 52 | about 53 |
| Navy Beans | about 134 | about 50 | about 46 |
| Green/Yellow Lima | about 140 | about 53 | about 53 |
| Red Beans | about 141 | about 50 | about 50 |
| Garbanzo | about 138 | about 49 | about 53 |
| Black Beans | about 139 | about 49 | about 49 |

As observed in the experiments illustrated in Table 3 above, beans are capable of being hydrated in accordance with the present invention in about half the time when compared to the control hydration experiment. Furthermore, beans, such as navy beans and light red kidney beans may be hydrated to a higher value when using the inventive method.

3. A Method of Processing a Vegetable Composition

It has been discovered that the enzyme-degraded vegetable composition of the present invention is capable of absorbing a second enzyme composition to degrade one or more anti-nutritional components in the first outer layer and/or second inner layer of the vegetable composition and thereby form an enzyme-processed vegetable composition.

The enzyme(s) that may be included as part of the second enzyme composition are carbohydrases, proteases or any combination thereof Any of the examples of carbohydrases as suitable for use during application of the first enzyme composition may be used as part of the second enzyme composition in any combination with the first enzyme composition, for degradation of any anti-nutritional component in accordance with the present invention.

As used herein, the term “protease” means any enzyme that is capable of at least catalyzing degradation of a protein-containing target substrate. One particular form of a protease that may be used in the second enzyme composition in accordance with the present invention is an endoprotease. As used herein, an “endoprotease” means any enzyme that is capable of degrading an internal peptide bond on a target substrate having one or more peptide bonds. Another particular form of a protease that may be used in the second enzyme composition in accordance with the present invention is an “exoprotease” As used herein, an “exoprotease” means any enzyme that is capable degrading a peptide bond located at a terminal portion of a target substrate having one or more peptide bonds. Either the endoprotease or the exoprotease may be derived from a number of different sources, such as fungal sources, plant sources, microbial sources, animal sources, or any combination of any of these.

Besides the carbohydrases and proteases, it is believed that other enzymes, such as oxido-reductases that are capable of at least catalyzing oxidation-reduction reactions on target substrates, transferases that are capable of at least catalyzing the transfer of functional groups on target substrates, hydrolases that are capable of at least hydrolyzing bonds, such as ester bonds or acid anhydride bonds on target substrates, lyases that are capable of at least adding onto a double bond on target substrates, isomerases that are capable of at least isomerizing bonds on target substrates, or ligases that are capable of at least forming bonds on target substrates, or any combination of any of these, provide sufficient degradation of any anti-nutritional component and are consequently suitable additional non-exhaustive examples for the second enzyme composition that may be used to degrade the anti-nutritional components of the vegetable composition in accordance with the present invention.

Oxido-reductases, transferases, hydrolases, lyases, isomerases, and ligases may be derived from a number of different fungal sources, plant sources, microbial sources, animal sources or any combination of any of these. Furthermore, it is believed the oxido-reductases, transferases, hydrolases, lyases, isomerases, and ligases and any of these listed second enzyme compositions s in any combination may be substituted in place of, or used in any combination with, the carbohydrases and/or the proteases for degradation and/or transformation of anti-nutritional components in accordance with the present invention. Some non-exhaustive examples of endoproteases and exoproteases include Alcalase®, Neutrase® Esperase®, Protamex, Novozym® FM, Flavourzyme®, and Kojizyme®, all available from Novo Nordisk Biochem North America of Franklinton, N.C., and Enzeco® exoprotease that is available from Enzyme Development Corporation of New York, N.Y.

While not wanting to be bound to theory, it is believed that the compromised integrity in the first outer layer of the enzyme-degraded vegetable composition allows the second enzyme composition to enter through the first outer layer to degrade any anti-nutritional components in the vegetable composition. Additionally, water included as part of the aqueous enzyme composition may also enter through the first outer layer to hydrate the vegetable composition. If water is continuously absorbed by the vegetable composition, the water in the vegetable composition may facilitate degradation of anti-nutritional components of the vegetable composition by the second enzyme composition.

Once sufficient degradation of the vegetable composition has occurred, the enzyme-processed vegetable composition may be drained of the aqueous enzyme composition and the vegetable composition further subjected to processing steps, such as, for example, blanching, that inactivates any enzyme component(s) that may remain in the vegetable composition. Alternatively, transferring the enzyme-processed vegetable composition still in the aqueous enzyme composition for further processing by freezing, hydrating, steaming, freeze-drying, canning, frying, boiling, drying, extrusion, cooking, baking, roasting, pulverizing, fermenting, enzyme, pasteurizing, extracting, milling, puffing, steam-pressure cooking, or any combination thereof, is also effective in deactivating any enzyme component(s) in the vegetable composition.

Partial degradation of anti-nutritional components in the first outer layer or the second inner layer of the vegetable composition may occur during application of the aqueous enzyme composition that includes the first enzyme composition to the vegetable composition. Thus, partial degradation or transformation of anti-nutritional components in the vegetable composition may also occur during or after application of the first enzyme composition.

Surprisingly, incorporating the second enzyme composition as part of the aqueous enzyme composition that also includes the first enzyme composition permits degradation of any anti-nutritional component within the vegetable composition during application of the first enzyme composition. Therefore, degradation of the first outer layer of the vegetable composition, along with degradation of any anti-nutritional component in the vegetable composition occurs at substantially the same time.

As a first example, an enzyme-degraded vegetable composition that includes flatulence-causing substrates is formed in accordance with the present invention. If a second enzyme composition that includes any enzyme component capable of degrading any flatulence-causing substrate, such as alpha-galactosidase, beta-fructofuranosidase, beta-galactosidase, invertase, or any combination thereof, is applied to the vegetable composition either during or after the first enzyme composition is applied to the vegetable composition, degradation of flatulence-causing substrates, such as raffinose, verbascose and stachyose in the vegetable composition typically occurs. The compromised integrity of the first outer layer of the enzyme-degraded vegetable composition may also allow any water present to be absorbed by the enzyme-degraded vegetable composition while the enzyme-degraded vegetable composition is being processed by the second enzyme composition Therefore, partial hydration of the enzyme-degraded vegetable composition may occur during processing by the second enzyme composition.

Generally, the second enzyme composition is applied to the enzyme-degraded vegetable composition for a time that is sufficient for the second enzyme composition to degrade the flatulence-causing substrates, such as, for example, about 1 minute to about 12 hours. Preferably, the second enzyme composition remains in contact with the vegetable composition for about 5 minutes to about 120 minutes and more than about 5 weight percent of flatulence-causing substrates are degraded in the vegetable composition when practicing the present invention.

The method of processing a vegetable composition in accordance with the present invention is a significant improvement in the art of vegetable processing. Typically, processing of vegetables is accompanied by high energy or equipment costs. The present invention accomplishes in situ processing of a vegetable composition without a high energy requirement nor a capital investment Furthermore, the use of complex solvents or chemicals traditionally used to accomplish vegetable processing may be eliminated.

Once sufficient processing of the vegetable composition occurs, the enzyme-processed vegetable composition may be drained of the aqueous enzyme composition and the vegetable composition further subjected to processing steps, such as, for example, blanching, that inactivates any enzyme component(s) that may remain in the vegetable composition. Alternatively, transferring the enzyme-processed vegetable composition still in the aqueous enzyme composition for further processing by freezing, hydrating, steaming, freeze-drying, canning, frying, boiling, drying, extrusion, cooking, baking, roasting, pulverizing, fermenting, enzyme, pasteurizing, extracting, milling, puffing, steam-pressure cooking, or any combination thereof, is also effective in deactivating any enzyme component(s) in the vegetable composition.

As a second example of the present embodiment, an enzyme-degraded vegetable composition that includes methylxanthine is formed in accordance with the present invention. As used herein, the term “methylxanthine” refers to the group of compounds used as a stimulant and diuretic typically found in vegetable compositions, such as tea, coffee, kola nuts, mate leaves, cacao bean, guarana and the like. It is understood that “methylxanthine” includes substituted forms of methylxanthine, such as, for example, caffeine. If a second enzyme composition that includes an enzyme component capable of degrading methylxanthine, is applied to the vegetable composition either during or after the first enzyme composition is applied to the vegetable composition, degradation of methylxanthine in the vegetable composition thereby occurs to reduce the level of methylxanthine in the vegetable composition.

Preferably, the second enzyme composition is applied to the enzyme-degraded vegetable composition for a time that is sufficient to degrade methylxanthine, such as, for example, about 1 minute to about 8 hours. Still more preferably, the second enzyme composition that includes the enzyme component capable degrading methylxanthine remains in contact with the vegetable composition for a time that is sufficient to degrade more than about 5 weight percent methylxanthine of the vegetable composition when practicing the present invention. The enzyme-processed vegetable composition with a reduced amount of methylxanthine may then be blanched to inactivate any enzyme component present in the vegetable composition, or further processed by pulverizing, grinding, milling, roasting, freezing, drying, freeze-drying, or any combination thereof. Subsequent additional processing by pulverizing, blending, grinding, paste-forming, roasting, freezing, drying, freeze-drying, extraction, or any combination thereof, may also deactivate the enzyme component(s).

The benefits of processing vegetable compositions that include methylxanthine in accordance with the present invention include reducing the need for expensive solvent extraction equipment and chemicals that are traditionally required to decaffeinate vegetable compositions, such as, for example coffee bean. Additionally, the present embodiment may improve the flavor of decaffeinated coffee beans which may result in an increase in market share for a decaffeinated coffee manufacturer selling the enzyme-processed coffee beans.

As a third example of the present embodiment, bitter flavor notes that characterize green unfermented cacao beans may be reduced in accordance with the present invention. An enzyme-degraded green unfermented cacao bean is formed in accordance with the present invention. As used herein, a “green unfermented cacao bean” includes cacao beans that do not have a sufficient quantity of amino acids and peptides required to form an acceptable cocoa flavor during subsequent roasting Furthermore, the “green unfermented cacao bean” include beans having less than about 40 weight percent moisture content and that have not been subjected to a fermentation step. Some non-exhaustive examples of green unfermented cacao bean that may be used in accordance with the present invention include beans derived from Theobroma sp., such as Ghanian cacao beans, Amelonado sp., Criollo, Forastero, or Trinitario.

If a second enzyme composition that includes an endoprotease, an exoprotease, or any combination thereof, is absorbed by the enzyme-degraded green unfermented cacao bean, degradation of protein in the green unfermented cacao bean occurs. Preferably, the endoprotease, the exoprotease, or any combination thereof, is capable of degrading protein that include hydrophobic amino acids and peptides that typically contribute to the bitter flavor notes that characterize green unfermented cacao beans. Still more preferably, the endoprotease, the exoprotease, or any combination thereof, is applied to the green unfermented cacao bean for a time, temperature, pH and moisture content of the green unfermented cacao bean that is sufficient to degrade the bitter flavor notes in the green unfermented cacao bean

While not wanting to be bound to theory, it is believed that the enzyme-degraded cacao bean includes sites through which the endoprotease, exoprotease, or any combination thereof, may be absorbed. Furthermore, the sites in the enzyme-degraded green unfermented cacao bean may facilitate subsequent natural fermentation of the green unfermented cacao bean by enhancing the capability of indigenous microflora of the natural fermentation process to colonize and digest the green unfermented cacao bean at the sites during the fermentation process.

The benefit of processing green unfermented cacao beans in accordance with the present invention include obtaining a less bitter cacao bean after fermentation and roasting steps. A less bitter cacao bean requires little flavor modification required during manufacture of cocoa containing products.

In an example of practicing the method of reducing the flatulence-causing substrates in a vegetable composition, about 740 grams of water was added to about 7.5 grams of vinegar and brought up to a temperature of about 150° F. About 2.5 milliliters of Viscozyme®L, and 2.5 milliliters of Alpha-Gal™ 600L, supplied by Novo Nordisk Biochem North America Inc., of Franklinton, N.C., were added to the vinegar and water mixture to form an aqueous enzyme composition with an initial pH of about 5.0. About 250 grams of collard greens were added to the aqueous enzyme composition and allowed to soak for about 30 minutes. The collard greens were then cooked for about 30 minutes at about 200° F. After cooking, the collard greens were drained and evaluated. Little, if any, flatulence was experienced after consumption of about 100 grams of collards even after 4 hours from the time of consumption of the collard greens.

In another example of practicing the method of reducing the flatulence-causing sugars in a vegetable composition, about 740 grams of water was added to about 7.5 grams of vinegar and brought up to a temperature of about 119° F. to about 123° F. About 2.5 milliliters of Viscozyme®L, and 1.25 milliliters of Alpha-Gal™ 600L, supplied by Novo Nordisk Biochem North America Inc., of Franklinton, N.C., were added to the vinegar and water mixture to form an aqueous enzyme composition with an initial pH of about 5.0. About 250 grams of great northern beans were added to the aqueous enzyme composition and allowed to soak for about 60 minutes. The great northern beans were then blanched for about 5 minutes at about 200° F. to deactivate the enzymes.

4. A Method of Modifying a Vegetable Composition

It has been discovered that the enzyme-degraded vegetable composition of the present invention is capable of absorbing additives to form a modified vegetable composition. The method of using one or more enzymes to modify a vegetable composition has been disclosed in Serial application Ser. No. 09/196,844. More specifically, Serial application Ser. No. 09/196,844 discloses that when beans are processed in accordance with the present invention, the pH of the aqueous enzyme composition generally increases over time. The increase in pH of the aqueous enzyme composition represents absorption of the vinegar by the beans during the hydration process. Some non-exhaustive examples of additives that may be used to practice the present invention include natural and/or artificial flavors; artificial colors; naturally-occurring pigments, such as, for example, chlorophyll, anthocyanin, betalain, betaine, carotenoid, anthoxanthins; herbs; spices; vitamins; minerals; plant extracts; essential oils; sugars such as sucrose, fructose, glucose, or maltose; preservatives; emulsifiers, such as mono-glycerides, distilled mono-glycerides, di-glycerides, distilled di-glycerides, or lecithin; or any combination of any of these The additives may be supplied as individual components, or supplied in various prepared mixtures of two or more components, that are subsequently combined to form the optional additives. The additives may also be applied before, during or after application of the first enzyme composition to the first outer layer of the vegetable composition.

The method of modifying a vegetable composition in accordance with the present invention is a significant improvement in the art of vegetable processing. Typically, a vegetable composition is mechanically modified, such as by peeling, grinding, pulverizing, prior to inclusion of an additive, followed by subsequent processing by conventional means. The added step of mechanical modification, along with any safety and health hazards that accompany using equipment involved in the mechanical modification of vegetables, may be eliminated when practicing the present invention. Additionally, the present invention accomplishes in situ modification of a vegetable composition without a capital investment

As an example of the present embodiment that modifies a vegetable composition, about 740 grams of water was added to about 7.5 milliliters of vinegar and brought up to a temperature of about 119° F. to about 123° F. About 2 5 milliliters of Viscozyme®L, supplied by Novo Nordisk Biochem North America Inc., of Franklinton, N.C., was added to the vinegar and water mixture to form an aqueous enzyme composition with an initial pH of about 4.8. About 250 grams of pinto beans were added to the aqueous enzyme composition and allowed to soak for about 60 minutes. The change in pH, indicating the absorption of vinegar is presented in Table 4 below:

TABLE 4

| TIME (minute) | TEMPERATURE (° F.) | pH |
|---|---|---|
| 0 | 123.1 | 4.78 |
| 15 | 118.5 | 5.11 |
| 30 | 117.7 | 5.38 |
| 45 | 118.9 | 5.56 |
| 60 | 119.2 | 5.70 |

5. Property Determination and Characterization Techniques

Various analytical techniques are employed herein. An explanation of these techniques follows. All values presented in this document for a particular parameter, such as moisture content, are based on the “as is” sample and are therefore on a “wet basis”, unless otherwise specified herein

To determine the weight percent hydration, in a particular sample, the sample is accurately weighed prior to application of the aqueous enzyme composition. The final weight of the enzyme-degraded sample and/or the enzyme-processed sample is then accurately determined after application of the aqueous enzyme composition. The weight percent hydration in the sample, is then calculated by subtracting the initial weight of the sample from the weight of enzyme-degraded or enzyme-processed sample. The difference is divided by the final weight of the enzyme-degraded sample and/or the enzyme-processed sample and multiplied by 100. The formula is written below:

$$\frac{{Weight}_{final} - {Weight}_{initial}}{{Weight}_{final}}$$

To determine the absorbency of water in a particular sample, the sample is accurately weighed prior to application of the aqueous enzyme composition. The final weight of the hydrated sample is then accurately determined after application of water to the vegetable composition. The absorbency of water in the sample, is calculated by subtracting the initial weight of the sample from the weight of the hydrated vegetable composition. The difference, expressed in grams of water absorbed by the vegetable composition, is divided by the amount of time that the water is applied to the vegetable composition.

To determine the specific absorbency, the absorbency of the vegetable composition is divided by the initial weight of the sample

6. Conclusion

In view of the foregoing disclosure and embodiments, it is believed that processing a vegetable composition in accordance with the present invention represents a significant improvement in the art of vegetable processing. The development of an effective process that reduces the complexity and costs associated with vegetable production, by reducing the first outer layer of a vegetable composition that typically hinders processing, creates a vegetable product with enhanced processing characteristics. Furthermore, the development of an in situ method of processing and modifying a vegetable composition greatly enhances the ability of a food manufacturer to produce vegetable products that offer a wide variety of nutritional characteristics to consumers.

Although the present invention has been described with reference to preferred embodiments, workers skilled in the art will recognize that changes may be made in form and detail without departing from the spirit and scope of the invention.

1. A method of processing a vegetable composition, the method comprising:
providing a vegetable composition which includes a first outer layer; and
applying a first enzyme composition to the first outer layer of the vegetable composition for a time that is sufficient to form an enzyme-degraded vegetable composition.

2. The method of claim 1 wherein the first enzyme composition comprises:
a cellulase, a hemicellulase, or any combination thereof;
an amount of enzyme that is effective in catalyzing the degradation of the first outer layer in the vegetable composition;
the enzyme at a temperature of between about 30° F. to about 250° F.; and
the enzyme at a pH of less than about 7.0

3. The method of claim 1 wherein the first enzyme composition degrades the first outer layer of the vegetable composition for at least 1 second.

4. The method of claim 1 wherein the first enzyme composition is effective in rendering the enzyme-degraded vegetable composition absorbent.

5. The method of claim 4 wherein the enzyme-degraded vegetable composition is capable of absorbing water at a rate of at least about 0 003 grams per minute per gram vegetable composition.

6. An enzyme-degraded vegetable composition having a first outer layer formed by the method of claim 1 that is in contact with an enzyme composition comprising a cellulase and a hemicellulase, or any combination thereof

7. The enzyme-degraded vegetable composition of claim 6 wherein the enzyme-degraded vegetable composition is useful as a vegetable product and further includes processing by freezing, drying, freeze-drying, canning, frying, hydrating, boiling, extruding, steaming, blanching, blending, cooking, baking, roasting, fermenting, peeling, pasteurizing, extracting, grilling, milling, puffing, micro-waving, enzyme, steam-pressure cooking, or any combination thereof.

8. An enzyme composition useful for the method of claim 1 in which the enzyme composition includes a cellulase, a hemicellulase, or any combination thereof.

9. The method of claim 1 wherein the vegetable composition is less than about 30 weight percent moisture.

10. The method of claim 9 and further including exposing the enzyme-degraded vegetable composition to water for a time that is sufficient for water to be absorbed by the enzyme-degraded vegetable composition.

11. An enzyme-degraded vegetable composition formed by the method of claim 1 that absorbs water for a time that is sufficient to form a hydrated vegetable composition of more than about 30 weight percent.

12. The vegetable composition of claim 11 wherein the hydrated vegetable composition is useful as a vegetable product and further includes processing by freezing, drying, freeze-drying, canning, frying, boiling, extruding, steaming blanching, peeling, blending, cooking, baking, roasting, fermenting, micro-waving, pasteurizing, extracting, milling, puffing, steam-pressure cooking, enzyme or any combination thereof.

13. The method of claim 1 and further including exposing the enzyme-degraded vegetable composition to a second enzyme composition for a time that is sufficient for the enzyme-degraded vegetable composition to absorb a second enzyme composition.

14. The method of claim 13 wherein the second enzyme composition is selected from alpha-galactosidase, mannanase, beta-gluconase, beta-glucanase, arabinase, xylanase, beta-galactosidase, invertase, beta-fructofuranosidase, alpha-amylase, beta-amylase, pectinase, pectin depolymerase, pectin methyl esterase, pectin lyase, glucoamylase, oligo-1,6 glucosidase, lactase, beta-d-glucosidase, or any combination thereof.

15. The method of claim 13 wherein the second enzyme composition comprises an enzyme that is effective in degrading methylxanthine.

16. The method of claim 13 wherein the second enzyme composition comprises a protease that is effective in degrading a hydrophobic amino acid containing protein, a hydrophobic amino acid containing peptide, or any combination thereof.

17. An enzyme-degraded vegetable composition having a first outer layer formed by the method of claim 1 that absorbs a second enzyme composition comprising an alpha-galactosidase, a beta-galactosidase, a beta-fructofuranosidase, an invertase, or any combination thereof, wherein the second enzyme composition is effective in degrading a flatulent-causing substrate.

18. The enzyme-degraded vegetable composition of claim 17 wherein the enzyme-degraded vegetable composition is useful as a vegetable product and further includes processing by freezing, drying, freeze-drying, canning, frying, boiling, extruding, steaming blanching, blending, cooking, baking, roasting, fermenting, peeling, micro-waving, pasteurizing, extracting, milling, puffing, steam-pressure cooking, enzyme or any combination thereof.

19. An enzyme composition useful for the method of claim 17 in which the enzyme composition includes a cellulase, a hemicellulase, an alpha-galactosidase, a beta-fructofuranosidase, an invertase, a beta-galactosidase, or any combination thereof.

20. The method of claim 1 wherein the vegetable composition is a tea leaf, a green coffee bean, a cacao bean, a mate leaf, a guarana, a cola nut, or any combination thereof.

21. An enzyme-degraded vegetable composition having a first outer layer formed by the method of claim 1 that absorbs a second enzyme composition comprising an enzyme that is effective in degrading methylxanthine, wherein the second enzyme composition is effective in degrading methylxanthine.

22. The enzyme-degraded vegetable composition of claim 21 and further including processing by pulverizing, blending, grinding, paste-forming, freezing, drying, freeze-drying, extraction, roasting, or any combination thereof

23. An enzyme composition useful for the method of claim 21 in which the enzyme composition includes a cellulase, a hemicellulase, an enzyme that is effective in degrading methylxanthine or any combination thereof.

24. The method of claim 1 wherein the vegetable composition is a green unfermented cacao bean which includes a first outer layer

25. An enzyme-degraded green unfermented cacao nut having a first outer layer formed by the method of claim 1 that absorbs a protease in an amount that is effective in degrading protein.

26. The enzyme-degraded green unfermented cacao nut of claim 25 and further including fermenting the green unfermented cacao nut.

27. An enzyme composition useful for the method of claim 24 in which the enzyme composition includes a cellulase, a hemicellulase, a protease, or any combination thereof.
